(19) United States
(12) Patent Application Publication
(10) Pub. No.: US 2024/0329276 A1
(43) Pub. Date: Oct. 3, 2024

(54) Metal Detector

(71) Applicant: Minelab Electronics Pty. Limited, Mawson Lakes (AU)

(72) Inventors: Philip Shane Wahrlich, Mawson Lakes (AU); Justin Thomas-Albury, Mawson Lakes (AU)

(21) Appl. No.: 18/620,242

(22) Filed: Mar. 28, 2024

(30) Foreign Application Priority Data
Mar. 31, 2023 (AU) 2023900922

(51) Int. Cl. G01V 3/38; G01V 3/10

(52) U.S. Cl. CPC G01V 3/38; G01V 3/10

(57) ABSTRACT

A method for reducing false positives of a metal detector in detecting a target, including transmitting a transmit magnetic field; receiving a receive magnetic field to produce a receive signal; processing the receive signal using at least two different functions to produce a first signal and a second signal; the at least two different functions are configured such that the first signal is sensitive to at least one characteristic of the target, and such that the second signal is a representation of a likelihood function of the first signal, the representation of the likelihood function taking into consideration an effect of an environment upon the first signal; and classifying the receive signal into a classification of one of at least three possible classes based on at least the second signal; and producing an indicator output signal based on the classification. The indicator output signal is different for different classifications and the indicator output signal includes an audio signal.

### CROSS-REFERENCE TO RELATED APPLICATION

This application claims priority to Australian Patent Application No. 2023900922 filed Mar. 31, 2023, the disclosure of which is hereby incorporated by reference in its entirety.

### BACKGROUND OF THE INVENTION

### Field of the Invention

The present disclosure relates to a metal detector.

### Description of Related Art

The general forms of most metal detectors which interrogate soil are either handheld battery-operated units, conveyor-mounted units, or vehicle-mounted units. Examples of handheld products include detectors used to locate gold; explosive land mines or ordnance; or coins and treasure. Examples of conveyor-mounted units include fine gold detectors in ore mining operations, and examples of a vehicle-mounted unit include a unit to locate buried land mines.

These metal detectors usually, but not necessarily, consist of transmit electronics generating a repeating transmit signal cycle of a fundamental period, which is applied to an inductor, for example a transmit coil, which transmits a resulting varying magnetic field, sometimes referred to as a transmit magnetic field.

These metal detectors may also contain receive electronics that process a receive signal from a measured receive magnetic field, during one or more receive periods during the repeating transmit signal cycle, to produce an indicator output signal, the indicator output signal at least indicating the presence of at least a metal target within the influence of the transmit magnetic field.

During the processing of the receive signal, the receive signal is demodulated to produce one or more target channels, the one or more target channels may be further processed to produce the indicator output signal.

It is desirable when operating a metal detector to maintain a low false alarm rate. There are many ways to define a false alarm. However, for the purpose of the present disclosure, in the broadest sense, a false alarm can be defined as an alert that leads to an attempted target retrieval without a desirable target being present.

There are other desirable properties when operating a metal detector, related to the false alarm rate. Typically, when a metal detector generates an audible alert, this alert encodes information related to properties of the electromagnetic interaction of the metal detector with the material close to the coil. For instance, the pitch of the audible alert may be modulated based on how components of the receive signal are phase-shifted relative to the transmit signal. Similarly, the loudness of the audible alert may be modulated based on how components of the receive signal are amplitude modulated. It is common for operators to use the information encoded in the audible alert to determine whether to attempt a target retrieval. It is also common for the signal-to-noise ratio of the receive signal to be very low, such that the modulation of the audible-alert is noisy and cannot be used to reliably indicate the presence of a desirable target, even with further time-consuming interrogation of the target area by the metal detector. Typically, such a situation results in a false alarm as many operators consider the cost of a false negative to be higher than the cost of a false positive. In other words, these operators would rather incur a false positive (attempt target retrieval without a desirable target being present), than to fail to retrieve a desirable target.

The present disclosure provides an alternative to reduce false positives when operating a metal detector.

### SUMMARY OF THE INVENTION

According to a first aspect of the present disclosure, there is provided a method for reducing false positives of a metal detector in detecting a target, comprising: transmitting a transmit magnetic field; receiving a receive magnetic field to produce a receive signal; processing the receive signal using at least two different functions to produce a first signal and a second signal; the at least two different functions are configured such that the first signal is sensitive to at least one characteristic of the target, and such that the second signal is a representation of a likelihood function of the first signal, the representation of the likelihood function taking into consideration an effect of an environment upon the first signal; and classifying the receive signal into a classification of one of at least three possible classes based on at least the second signal; and producing an indicator output signal based on the classification, wherein the indicator output signal is different for different classifications; the indicator output signal comprising an audio signal.

In one form, the at least one characteristic of the target is related to the magnetic polarizability of the target.

In one form, the first signal is a numeric indicator denoting the at least one characteristic of the target.

In one form, the second signal is used to predict the variability of the first signal due to the effect of the environment.

In one form, the indicator output signal is further indicative of a classification uncertainty in identifying a group to which the target belongs.

In one form, the indicator output signal comprises an audio signal with at least a first tone when a confidence level is below a first threshold indicating that a presence of the target is of low probability; and wherein the indicator output signal comprises an audio signal with at least a second tone different from the first tone when the confidence level is above a second threshold indicating that a presence of a first type of target is of high probability; and wherein the indicator output signal comprises an audio signal with at least a third tone different from the first and second tones when the confidence level is above a third threshold indicating that a presence of a second type of target different from the first type of target is of high probability.

In one form, producing the second signal comprises combining information from the receive signal prior to detecting the target with information from the receive signal associated with detecting the target. In one form, combining the information from the receive signal prior to detecting the target with information from the receive signal associated with detecting the target comprises calculating a measure of noise in a component of the receive signal prior to detecting the target and inferring the noise in the first signal that is sensitive to an identity of the target, assuming that a similar level of noise is present in the receive signal associated with detecting the target. In one form, the component of the receive signal prior to detecting the target is sensitive to the soil. In one form, the component of the receive signal prior to detecting the target is sensitive to seawater. In one form, the component of the receive signal prior to detecting the target is sensitive to electromagnetic interference.

According to another aspect of the present disclosure, there is provided a metal detector configured to perform the method of the first aspect.

According to another aspect of the present disclosure, there is provided a non-transitory computer readable medium, comprises instructions to perform the method of the first aspect.

### BRIEF DESCRIPTION OF THE DRAWINGS

Embodiments of the present disclosure will be discussed with reference to the accompanying drawings wherein:

FIG. 1 depicts one embodiment of the present disclosure;

FIG. 2A depicts an example wherein the signals are reliably non-ferrous and FIG. 2B depicts an example wherein the signals are unreliable; and

FIGS. 3A and 3B depict an operation of a metal detector according to one embodiment of the present disclosure in detecting a target.

### DESCRIPTION OF THE INVENTION

The present disclosure teaches means to reduce false positives when operating a metal detector. This is achieved by dynamically estimating the susceptibility of the metal detector to misclassify a signal, and altering the information communicated by the metal detector to the operator based on this susceptibility.

Factors that can affect the signal-to-noise ratio of the receive signal include the response from magnetic soils, saline environments such as conductive soil and seawater, as well as electromagnetic interference (EMI) and the electronic noise produced by the metal detector.

Measurements of the noise level associated with each noise source, or combinations of noise sources, can be made at different times than the measurements of the signal to be used to communicate the potential presence of a desirable target to the operator. For instance, measurements of the noise levels associated with each noise source could be made at a time prior to the time of measurement of the signal to be used to communicate the potential presence of a desirable target to the operator. The measurement of such noise levels can be used to infer the variability of the information to be communicated to the operator. When the variability is inferred to be sufficiently high, it may be desirable to suppress the communication of this information to the operator. When the inferred variability is lower, but still moderately high, it may be desirable to express the level of inferred variability in the information communicated to the operator, for example by modulating the audible alert.

It is important to note that the variability in the information to be communicated to the operator may be non-stationary over space, but stationary over time. Specifically, the deviation from the true target information of the information that is to be communicated to the operator may be predominantly due to additive noise associated with the response from the soil surrounding the target, which does not change with time. Nonetheless, by measuring the level of this additive noise, the impact of this noise on the information to be conveyed to the operator can be inferred.

The method by which the noise is measured can introduce error in the measurement of the noise. It is preferable to measure the noise when there is reasonable confidence that the relevant noise is present and free of significant corruption by the presence of other signals, such as metallic objects, desirable or not. Such a measurement can be achieved by first classifying a receive signal as being suitable for being included as part of the measurement of noise and including only those receive signals that are classified as such.

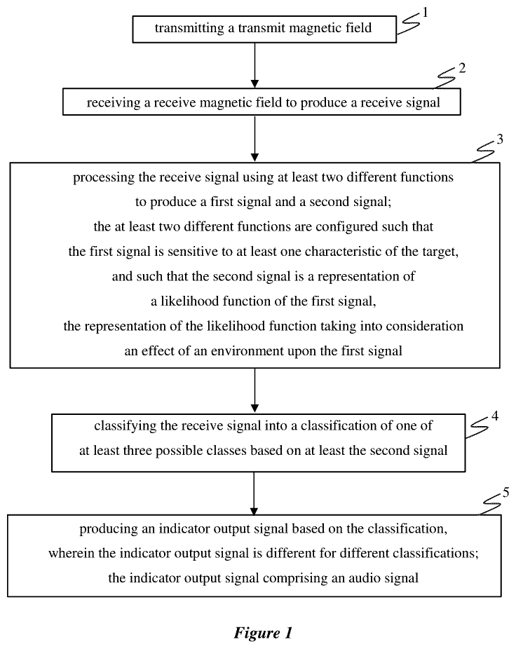

A general form of one embodiment of the present disclosure to reduce false positives of a metal detector in detecting a target as indicated in FIG. 1 comprises the following steps:

Step 1: transmitting a transmit magnetic field. Any known method of transmitting a transmit magnetic field suitable for metal detection may be used in conjunction with a suitable transmitter deemed suitable by a person skilled in the art.

Step 2: receiving a receive magnetic field to produce a receive signal. In this context, receive magnetics fields are magnetic fields received by the receiver of the metal detector. Receive magnetic fields due to the transmit magnetic field are the magnetic fields generated in response to the transmit magnetic field. For example, a target in an influence zone of the transmit magnetic field would have eddy currents generated within, and the eddy currents in turn generate a magnetic field. Once the receiver has started receiving the receive magnetic fields due to the transmit magnetic field, receive signals are generated, just like any other metal detectors.

Step 3: processing the receive signal using at least two different functions to produce a first signal and a second signal; the at least two different functions are configured such that the first signal is sensitive to at least one characteristic of the target, and such that the second signal is a representation of a likelihood function of the first signal, the representation of the likelihood function taking into consideration an effect of an environment upon the first signal.

“Functions” may involve synchronous demodulation functions and mathematical functions applied to the receive signal through, for example, mixing or multiplication. It is also possible to first digitize the receive signal prior to processing the receive signal. Since the at least two functions are different, the at least two produced signals, the first signal and the at least second signal, would be different. The term “sensitive” in this context simply means “indicative” or “representative”. “Environmental effects” means “changes due to surroundings”. “Environmental effects” comprise changes due to soil, water, moisture, sea water, electromagnetic interference (EMI) etc. Characteristics of the target may be the identity of the target, a group which the target belongs such as ferrous, non-ferrous etc., frequency response of the target, time constant of the target, the similarity of the target to a ferrous object, the similarity of the target to a non-ferrous object, a magnetic polarizability tensor representing the target, a property of a magnetic polarizability tensor representing the target, etc.

Alternative Step 3A: processing the receive signal using at least two different functions to produce a first signal and a second signal; the two different functions are configured such that the first signal is sensitive to identify a group which the target belongs among selected groups, and such that the second signal is sensitive to a predicted variability of the first signal due to environmental effects.

Alternative Step 3B: processing the receive signal using at least two different functions to produce a first signal and a second signal; the at least two different functions are configured such that the first signal is sensitive to at least one characteristic of the target, and such that the second signal is indicative of an effect of an environment upon the first signal.

When the first signal is sensitive to identify a group which the target belongs, it means that the first signal may be used to identify a group which the target belongs. Alternatively, the first signal may contain data or information to identify a group which the target belongs. An example of possible groups is a ferrous group and non-ferrous group. Alternatively, the electromagnetic properties of the target can be grouped into different ranges. The term “selected” does not limit when the selection is performed. The selection may be preselected or changed or updated by an operator when operating the metal detector. The term “predicted” means “estimated”. The term “variability” means irregularity or changeability. This is different from the term “uncertainty”, which refers to the quantitative measure of the measure of the dispersion around the true value or the mean value of a set of data points. In combination, the phrase “second signal is sensitive to a predicted variability of the first signal due to environmental effects” means that the second signal may contain data or information in relation to how the environmental effects affect the first signal. In other words, the second signal is used to predict the accuracy of the first signal in classifying the target based on the selected groups.

Step 4: classifying the receive signal into a classification of one of at least three possible classes based on at least the second signal. The three possible classes may be ferrous, non-ferrous and indeterminate.

Step 5: producing an indicator output signal based on the classification, wherein the indicator output signal is different for different classifications; the indicator output signal comprising an audio signal.

Alternative Step 5A: processing the first signal and the second signal to produce an indicator output signal indicative of a variability of the first signal due to the effect of the environment.

The indicative output signal may be an audio signal, visual signal or a vibration, or a combination thereof. Based on the output signal, an operator of the metal detector may have a better idea regarding the accuracy of the first signal. Preferably, the indicative output signal is an audio signal. For example, a weaker tone may mean lower confidence regarding the accuracy of the first signal. Alternatively, a louder tone means higher confidence regarding the accuracy of the first signal. It is useful to convey to the operator at least three different classes of detection: a first classes wherein the object is confidently classified as a first type of object, a second class wherein the object is confidently classified as a second type of object, and a third class wherein the object is not confidently classified as either a first type of object or a second type of object.

The following is a working example:

```
FOR EACH sample
  Classify sample as soil if g(R,X) > 0
  IF sample is soil
    Insert X into buffer B_{X}
    Delete oldest element of B_{X}
  Calculate T = f(R,X)
  Calculate Tᵤₚₚₑᵣ = f(R,X + MAX(B_{X}))
  Calculate N = DISTANCE(Tᵤₚₚₑᵣ,T)
  IF N > threshold
    Volume = 0
  ELSE
    Volume = h(R,X,T)
```

The above working example applies to digitised signals. R is a signal that is sensitive to the resistive component of the target and X is a signal that is sensitive to the reactive component of the target. An example of a resistive signal R is the quadrature component of a receive signal following demodulation. An example of a reactive signal X is the in-phase component of a receive signal following demodulation. A soil classification function classifies a sample as being associated with the response from soil based on the R and X signals. This can be achieved by specifying a decision boundary in the space spanned by the R and X signals which best separates the responses from soil from the responses from targets.

If at a particular time the sample is classified as being associated with the response from soil, information from this particular time can be used to estimate the variability of future measurements due to the soil. A record is kept in buffer B_{X} of recent X values that are classified as being due to the response from soil.

Whenever a target is detected, a target identity value T is calculated. T=ƒ(R,X) is a function of the signals R and X. An example of such a function is ƒ(R,X)=tan⁻¹(R/X). To assess by how much the target identity value T could be altered in the presence of historically measured noise, the maximum amount of soil-classified X is added to the instantaneous X, and the target identity value T is calculated again with this new sum. In other words, the hypothetical target identity value is calculated for a scenario wherein the maximum soil-classified, historical X values were added to the measured X value associated with the potential target response.

The distance between the old and new target identity values provides us with a measure of how much the target identity value may be perturbed by the soil response, given the historical values of X, under the assumption that the historically measured variations in X persist at the time of calculating the target identity value T. If the perturbation is sufficiently large, the target identity value will be unreliable, and for the operator of the metal detector, reporting this unreliable target identity poses a problem of creating the unwanted cognitive burden of a high false alarm rate. In this case, the output volume of the metal detector is set to zero, suppressing the unreliable alert. Otherwise, the output is a normal non-zero volume alert. In this example, N is an example of a second signal indicative of an effect of an environment upon the first signal. The DISTANCE function quantifies the how far apart the two arguments are. For example, the Euclidian distance can be used as a DISTANCE function. Alternatively, and inverse similarity measure can be used as a DISTANCE function, e.g., the inverse cosine similarity.

The following is a second working example:

```
FOR EACH sample
  FOR EACH bootstrap sample (N)
    Calculate Rᵢ = R + B_{R}_{ᵢ}
    Calculate Xᵢ = X + B_{X}_{ᵢ}
    Classify F = f (Rᵢ,Xᵢ)
    IF F is TRUE
      Increment counter N_{F}
  Calculate L = N_{F}/N
  IF L > threshold
    Volume = 1
  ELSE
    Volume = 0
  Insert X into buffer B_{X}
  Insert R into buffer B_{R}
  Delete oldest element of B_{X}
  Delete oldest element of B_{R}
```

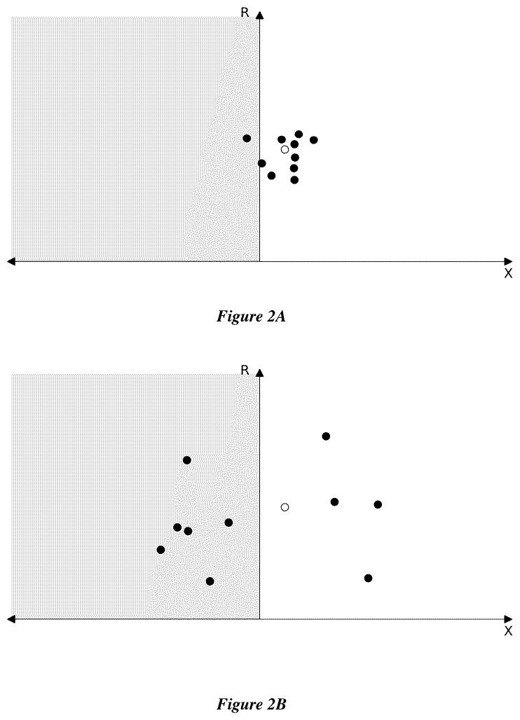

In the above working example, a record is kept in buffer B_{X} of recent X values and a record in buffer B_{R} of recent R values. Replacement N is sampled with times from each buffer to generate N new pairs of Rᵢ, Xᵢ=R+B_{R}_{ᵢ}, X+B_{X}_{ᵢ}. In other words, Rᵢ, Xᵢ pairs are sampled from the buffers using a bootstrap method, adding the values sampled from the buffers to the nominal R, X pair. Each pair is then classified as ferrous or non-ferrous using a function ƒ(Rᵢ, Xᵢ). An example of such a function is to compare each Rᵢ, Xᵢ pair to a decision boundary to classify it as ferrous if it falls inside a ferrous decision region (the shaded area), or non-ferrous if it falls outside the ferrous decision region. The fraction of pairs is then calculated, L, classified as non-ferrous compared to ferrous. If the fraction is above a threshold, then the metal detector outputs a nominal non-zero volume, otherwise the metal detector sets the output volume to zero, suppressing the unreliable alert. FIG. 2A depicts an example wherein the signals are reliably non-ferrous and FIG. 2B depicts an example wherein the signals are unreliable. In particular, FIG. 2A depicts the sampled Rᵢ, Xᵢ pairs in relation to the target. Most pairs fall outside the ferrous decision boundary (shaded area) and inside the non-ferrous decision boundary, therefore the signals are reliably non-ferrous. In contrast, FIG. 2B depicts that the fraction of pairs falls inside the ferrous decision boundary (shaded area) and inside the non-ferrous decision boundary is below a threshold value (for example ⅔, ¾ etc.), thus the signals are unreliable.

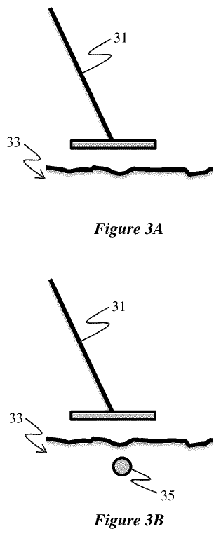

FIGS. 3A and 3B depict another exemplary embodiment. In this embodiment, as shown in FIG. 3A, a metal detector 31 measures noise in a receive signal at time T1 without a target in soil 33. With the presence of a target 35 in soil 33, as shown in FIG. 3B, the metal detector calculates a characteristic of the target such as the target identity value of the target at time T2. Thereafter, the metal detector calculates the inferred variability in the target identity value based on both the noise measured at time T1 and the receive signal at time T2. Thereafter, the metal detector calculates audio responses based on the target identity value and the inferred variability of the target identity value.

In this specification the terms “ground” and “soil” are used interchangeably. As understood by a person skilled in the art, the terms “ground” and “soil” mean surfaces of earth wherein targets may be contained within. The surfaces are often solid, may be homogenous or may be a combination of various soil types, and may contain moisture or water.

Those of skill in the art would understand that information and signals may be represented using any of a variety of technologies and techniques. For example, data, instructions, commands, information, signals, bits, symbols, and chips referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope of the disclosure as set forth and defined by the following claims.

1. A method for reducing false positives of a metal detector in detecting a target, comprising the steps of:
transmitting a transmit magnetic field;
receiving a receive magnetic field to produce a receive signal;
processing the receive signal using at least two different functions to produce a first signal and a second signal; the at least two different functions are configured such that the first signal is sensitive to at least one characteristic of the target, and such that the second signal is a representation of a likelihood function of the first signal, the representation of the likelihood function taking into consideration an effect of an environment upon the first signal;
classifying the receive signal into a classification of one of at least three possible classes based on at least the second signal; and
producing an indicator output signal based on the classification, wherein the indicator output signal is different for different classifications; the indicator output signal comprising an audio signal.

2. The method of claim 1, wherein the audio signal includes tones of different pitches for different classes.

3. The method of claim 1, wherein the audio signal is not emitted for a particular class.

4. The method of claim 1, wherein the at least one characteristic of the target is related to the magnetic polarizability of the target.

5. The method of claim 1, wherein the indicator output is a numeric indicator denoting the at least one characteristic of the target.

6. The method of claim 1, wherein the second signal is used to predict the variability of the first signal due to the effect of the environment.

7. The method of claim 1, wherein the indicator output signal is further indicative of a classification uncertainty in identifying a group to which the target belongs.

8. The method of claim 1, wherein producing the second signal comprises combining information from the receive signal prior to detecting the target with information from the receive signal associated with detecting the target.

9. The method of claim 8, wherein combining the information from the receive signal prior to detecting the target with information from the receive signal associated with detecting the target comprises calculating a measure of noise in a component of the receive signal prior to detecting the target and inferring the noise in the first signal that is sensitive to an identity of the target, assuming that a similar level of noise is present in the receive signal associated with detecting the target.

10. The method of claim 8, wherein the component of the receive signal prior to detecting the target is sensitive to the soil.

11. The method of claim 8, wherein the component of the receive signal prior to detecting the target is sensitive to seawater.

12. The method of claim 8, wherein the component of the receive signal prior to detecting the target is sensitive to electromagnetic interference.

13. A metal detector configured to perform the method of claim 1.

14. A non-transitory computer readable medium, comprising instructions to perform the method of claim 1.
